(19) United States
(12) Patent Application Publication
(10) Pub. No.: US 2024/0410785 A1
(43) Pub. Date: Dec. 12, 2024

(54) PRECISE BEARING MEASUREMENT DEVICE

(71) Applicants: Laser Technology, Inc., Centennial, CO (US); Kama-Tech (HK) Limited, Hong Kong (HK)

(72) Inventors: Jeremy G. Dunne, Parker, CO (US); Eric A. Miller, Englewood, CO (US); Derrick T. Reish, Denver, CO (US); William E. Rett, Centennial, CO (US)

(73) Assignees: Laser Technology, Inc., Centennial, CO (US); Kama-Tech (HK) Limited, Hong Kong (HK)

(21) Appl. No.: 18/207,978

(22) Filed: Jun. 9, 2023

(51) Int. Cl. G01M 13/04; G01C 3/10; G01C 9/10

(52) U.S. Cl. CPC G01M 13/04; G01C 3/10; G01C 9/10; G01C 2009/102

(57) ABSTRACT

A precise bearing measurement device wirelessly couplable to an associated rangefinder for providing the rangefinder with the horizontal bearing of the device. The device comprises a rotor board and parallel and spaced apart resolver board to which it is capacitively coupled. A processor and an inclinometer are provided to ensure the device is maintained in a level orientation when taking a bearing measurement.

### BACKGROUND OF THE INVENTION

The present invention relates, in general, to the field of precise bearing measurement devices. More particularly, the present invention relates to a horizontal angle measurement device in conjunction with a laser-based rangefinder or speed gun associated therewith utilized, for example, in geographic information system (GIS) mapping, global positioning system (GPS), and global navigation satellite system (GNNS) applications.

Pulsed laser rangefinders calculate distance by measuring the time of flight of very short pulses of infrared light. This differs from the traditional surveying instrument method of measuring phase shifts by comparing the incoming wavelength with the phase of the outgoing light.

Any solid object will reflect back a certain percentage of the emitted light energy from a laser rangefinder. This only needs to be a small percentage for a suitably sensitive detector to pick it up. By accurately measuring the time it takes a laser pulse to travel to the target and be reflected back with a precision time base, and knowing the constant speed of light, it is then possible to calculate the distance traveled to determine the distance from the rangefinder to the target.

For increased accuracy, such laser-based rangefinders may process as many as sixty or more pulses in a single measurement period. Target acquisition times range from 0.3 to 0.7 seconds. Sophisticated accuracy validation algorithms are utilized to ensure a reliable reading of distance to the target.

Laser Technology, Inc., assignee of the present technology, has previously introduced the MapStar® Angle Encoder and the MapStar TruAngle® device for use in conjunction with cable-coupled laser-based rangefinders. The current TruAngle devices have an angular accuracy of +/−0.05° and may be coupled to a TriBach mount for securing the TruAngle combination to a tripod when in use. The TriBach mount comprises an attachment plate with a bubble level used to attach a laser rangefinder, surveying instrument, a theodolite, total station, GNSS antenna, or target to a tripod.

Due to the requirement of cable coupling of the current TruAngle device to a laser-based rangefinder or speed measurement unit, the use of a bubble level may be required to ensure the combination is secured in a precise horizontal plane as well as other factors. Laser Technology, Inc. has developed an improved precise bearing measurement device as more fully described and disclosed hereinafter.

### SUMMARY OF THE INVENTION

The precise bearing measurement device of the present technology can calculate a turned horizontal angle that can be referenced to any desired point or direction. The device of the present technology can be operative in conjunction with all of the assignee's laser rangefinders that measure range and inclination (tilt) values. When paired together with one of these rangefinders, the present technology can provide accurate and complete three-dimensional (3D) position measurements by calculation of the X, Y and Z coordinates of a target.

The modular design of the device in conjunction with a laser rangefinder can allow a user to pivot the laser rangefinder a full 90 degrees up or down while maintaining the precise bearing measurement device of the present technology level thereby providing the greatest possible accuracy and range of motion. Horizontal accuracies of +/−0.1 degree can be achieved including up to as fine a resolution as +/−0.02 with proper mounting.

In accordance with a representative embodiment of the present technology, wireless communication with the associated laser rangefinder may be achieved by either Bluetooth Classic or Bluetooth Low Energy (BLE) communications protocols. The representative embodiment of the present technology disclosed herein may be powered by a rechargeable lithium-ion battery which can provide up to 12 hours of continuous use. The device itself may be provided in a package size approximating that of a hockey puck and is mountable to, for example, a global positioning system monopole, tripod, or the like in order to maintain a level orientation.

A representative embodiment of the present technology can incorporate a processor and an associated set of accelerometers to provide a level indication to a user in order to obtain the highest degree of positional accuracy. Through the use of a number of light emitting diodes (LEDs) and haptics, a user can be accurately apprised of the level of the precise bearing measurement device or how to reposition the device to obtain an accurate level without the need for a liquid crystal display (LCD) or other display technology.

In combination with, for example, a Laser Technology, Inc. TruPulse® 200X, the capability offered by the bearing measurement device of the present technology can allow for the extremely accurate location of a target point with range, inclination, and azimuth. This data can then be used to calculate the remote location point coordinates from a known GPS coordinate of an otherwise inaccessible or GPS-challenged position.

A device in accordance with the present technology is herein described and disclosed may have an environmental rating of IP67 and may conveniently incorporate a friction mechanism or brake to hold a desired angle and not rotate while moving the device and the rangefinder around.

Particularly disclosed herein is a precise bearing measurement device which may comprise a housing rotatably supported about a shaft couplable to a support with the housing being couplable to a rangefinder. A rotator board within the housing can be coupled to the shaft and a parallel and spaced apart resolver board can be capacitively coupled therewith, the housing being affixed to the resolver board. A processor can be coupled to receive a signal indicative of a relative position of the rotator and resolver boards indicative of a horizontal bearing of the resolver board and the housing. A wireless communication medium may be provided for communicating the bearing to said rangefinder.

Further specifically disclosed herein is a precise bearing measurement device which may comprise a rotor comprising a plurality of concentric annular conductive rings formed on a lower planar surface thereof and a resolver comprising a number of concentric annular conductive rings formed on an upper surface thereof spaced apart from and opposing the rotor lower surface. The conductive rings of the rotor and the resolver can be capacitively coupled and relatively rotatable with respect to one another. A processor may be coupled to selected segments of at least one of the number of resolver conductive rings for providing an indication of the respective position of the rotor and resolver with respect to one another.

Still further disclosed herein is a range pole leveling device comprising a processor and a set of accelerometers coupled to the processor for sensing a level or off-level position of the device. A plurality of level indicating LEDs can be coupled to the processor and peripherally disposed about the pole wherein a first group of the LEDs can be operative to illuminate when the device is at a level position and a second group of the LEDs can be operative to illuminate when the device is at an off-level position.

### BRIEF DESCRIPTION OF THE DRAWINGS

The aforementioned and other features and objects of the present technology and the manner of attaining them will become more apparent and the technology itself will be best understood by reference to the following description of a preferred embodiment taken in conjunction with the accompanying drawings, wherein:

FIGS. 1A and 1B are opposite side elevational views of a precise bearing measurement device in accordance with a representative embodiment;

FIGS. 1C and 1D are opposite side isometric views of the device of FIG. 1 further illustrating a battery compartment cover portion of the housing and the top plate thereof;

FIG. 1E is a top plan view of the top plate of the preceding FIGS. 1C and 1D illustrating possible user viewable indicators and actuator buttons thereof;

FIG. 2A is a cut-away side elevational view of the representative device of the preceding figures illustrating additional internal structure thereof;

FIG. 2B is a cut-away isometric view of the device of the preceding figure illustrating another view of the internal structure thereof;

FIG. 2C is an exploded isometric view of the device of the preceding figure illustrating in greater detail the rotor and resolver boards;

FIG. 2D is an enlarged isometric view of a portion of the device of FIGS. 2A-2C further illustrating the relationship between the rotor and resolver boards;

FIG. 3A is a bottom plan view of a possible rotor board configuration in accordance with a representative embodiment of the device as illustrated in the preceding figures;

FIG. 3B is a top plan view of a possible resolver board configuration in accordance with the representative embodiment of the device as illustrated in the preceding figures for use in conjunction with the rotor board of FIG. 3A;

FIGS. 3C and 3D illustrate, respectively, the resultant demodulated states of segments A&D and B&C as differential square wave signals of quadrants A&B with C&D as well as quadrants A&D with B&C;

FIG. 4A illustrates the cosine (COS) and sine (SIN) states of each of segments A, B, C, D as differential triangular wave signals which are the result of the demodulation of square wave signals at these segments at positions 0 through 4 and the resultant outputs varying between +1.0 and −1.0;

FIGS. 4B and 4C illustrate the calculations for the values of segments A, B, C, D of the preceding figures with respect to the absolute value of the sine and cosine for each of these segments; and

FIG. 5 is a high-level functional block diagram illustrative of possible circuitry for implementing the functional and operational characteristics of the representative device of the preceding figures.

### DESCRIPTION OF A REPRESENTATIVE EMBODIMENT

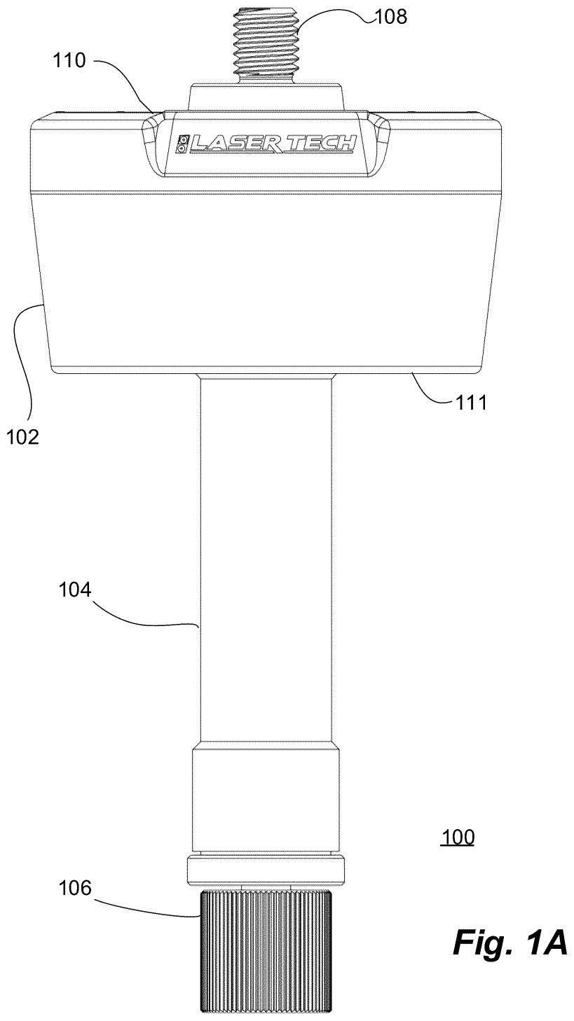

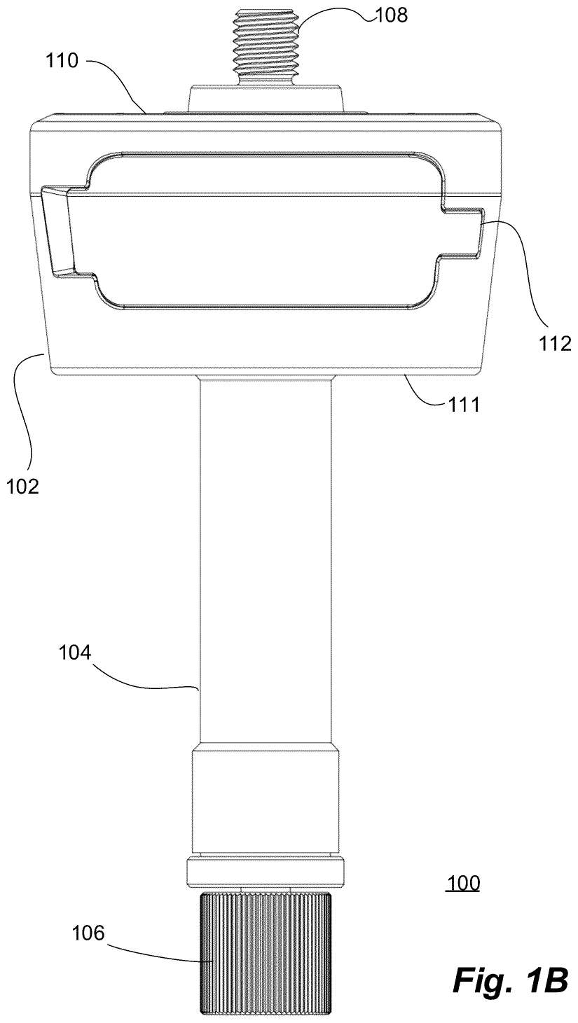

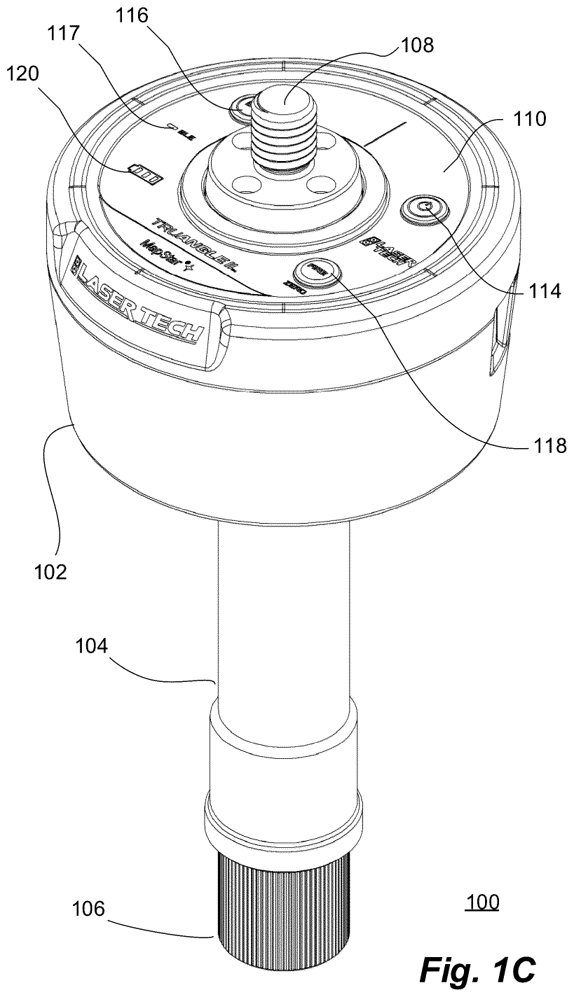

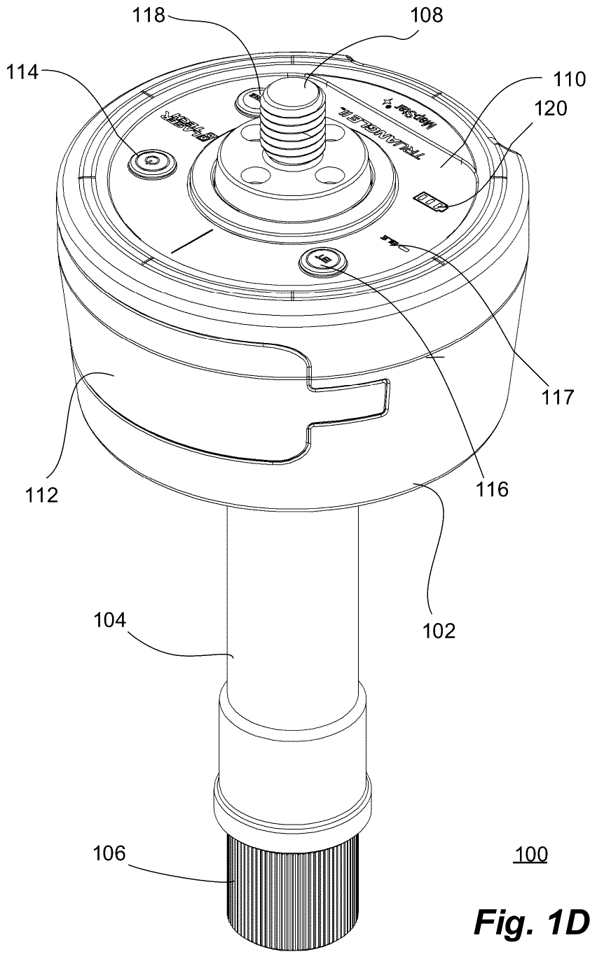

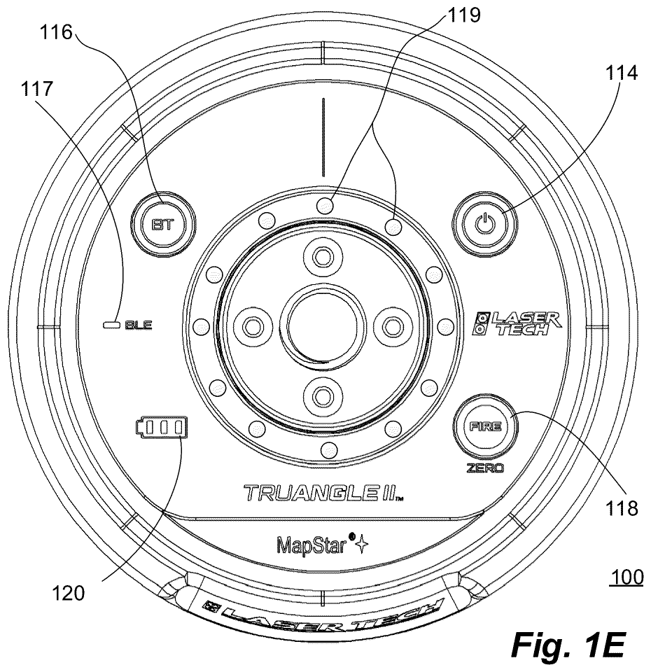

With reference now to FIGS. 1A and 1B, opposite side elevational views of a precise bearing measurement device 100 in accordance with a representative embodiment are shown.

The device 100 comprises a cylindrical housing 102 which is rotatable in conjunction with an outer cylinder 104 to which it is affixed about an internal shaft (not shown but disclosed and described hereinafter) coupled to a support adapter coupler 106 as will be more fully described hereinafter.

A laser-based rangefinder (or speed measurement device in other applications) may be paired with and utilized in conjunction with the device 100. The laser rangefinder may be coupled to the mounting post 108 by means of a hinged coupler allowing the rangefinder to operationally traverse+/−vertical angles while remaining horizontally fixed with respect to the device 100. Alternatively, a section of a GPS pole may be attached to the mounting post 108 with the laser rangefinder attached by a hinge to the GPS pole to be allowed to pivot vertically. As illustrated, the mounting post 108 can be coupled to a top plate 110 of the housing 102 such that a laser-based rangefinder associated with the post 108 can be rotated in conjunction with the housing 102. A lower plate 111 defines the bottom portion of the housing as will be more fully described hereinafter.

With reference additionally now to FIGS. 1C and 1D, opposite side isometric views of the device 100 of FIGS. 1A and 1B are shown further illustrating the battery compartment cover 112 portion of the housing 102 and the top plate 110 thereof.

As illustrated, the top plate 110 comprises a number of user inputs, actuator buttons, and visual indicators are shown as will be more fully described with respect to the following figure.

With reference additionally now to FIG. 1E, a top plan view of the top plate 110 portion of the device 100 of the preceding FIGS. 1C and 1D is shown illustrating possible user viewable indicators, inputs, and actuator buttons thereof. These comprise, in the representative embodiment illustrated a Fire/Power on/off button 114, a Bluetooth pairing button 116, a BLE indicator 117, a Fire/Zero button 118, a circular array of LEDs 119, and a battery charge status indicator 120.

Only the Fire/Zero Power on/off button 114 may be active when the device 100 is in a power off state. Short presses of the button 114 can light up the battery charge status indicator 120 showing the battery status for 3 seconds which will then power off the indicator 120. The duration of the illumination of the indicator 120 may be programmable.

A longer depression of the Fire/Power on/off button 114 can turn on the device 100 (e.g., hold for 2 seconds then release). This can cause the LEDs 119 to all flash a number of times for a determined period of time or sequentially light in a clockwise or counter clockwise pattern and then remain on for a short period of time and then turn off.

At this point, the LEDs 119 can indicate the current level or tilt orientation of the device 100 in conjunction with a haptic indication as to whether the device 100 is level or not. Short depressions of the button 114 can also cause the illumination of the battery charge status indicator 120 which will then turn off after a determined period of time which can be programmable.

In order to manually turn off the device 100, the button 114 can be depressed for a relatively longer period of time and may also be programmable. The LEDs 119 may then all be illuminated as the device 100 shuts down. The device 100 may be programmed to automatically turn off should no other buttons be pressed, or no angle is measured after approximately 30 minutes or other determined period of time. In order to save the device 100 batteries, this predetermined power off interval can automatically power the device 100 down if no activity is sensed for the time period defined. This non-activity may comprise no button presses, no angle change, no rotation measurements, or no device 100 tilt level changes. Any such activity can serve to reset the auto power down timer. Automatic power down can also occur even if the device 100 is Bluetooth coupled to a paired laser rangefinder. In a representative embodiment of the present technology, the device 100 default time can be configurable via a BLE protocol setting Timeout Interval Set function.

With respect to the Fire/Zero function of the Fire/Zero Power on/off button 114, a short press can accept the current horizontal orientation value of the device 100 and the value may be downloaded to the paired laser rangefinder via Bluetooth communication. At this point, the level assist LEDs 119 may all flash a determined number of times (e.g., 3 times) indicating that the device 100 has taken a horizontal measurement and the value has been downloaded.

A long press of the button 114 (e.g., press and hold for 3 seconds; duration is programmable) can invoke the zero-degree quick reference feature that sets the horizontal angle determined by the device 100 to zero degrees (0.00°) and references all turned angles to that user-defined heading. The level-aid LEDs may then also be illuminated in a determined pattern to indicate that the device 100 has been “zeroed” and then turn off and then begin displaying the current device 100 tilt orientation.

With respect to the Bluetooth button 116, this button can, with respect to BLE, create low data rate networks using a minimum amount of power. The BLE indicator 117 may indicate the status of the pairing. A long press of the button 116 (e.g., for 3 seconds or other programmable time interval) can initiate the Bluetooth pairing (discovery mode) set up with a third-party device. The BLE indicator 117 can flash in the discovery mode and can remains on continuously when the device 100 is paired/connected. The BLE indicator 117 may remain on when the device 100 is paired and powered on thereby also providing a visual indication that the device 100 is powered on.

The device 100 may also be couple to a laser rangefinder having Bluetooth Classic or BLE connectivity to the device 100 through a smartphone with Bluetooth options and an associated application (app). In this configuration the app and the smartphone (or other smart device) can be utilized to control connectivity to the laser rangefinder and the device 100. The smartphone can detect the Bluetooth options and connect to the laser rangefinder and the device 100 individually.

The app on the smartphone can then fire the laser rangefinder and capture the measurement taken (e.g., slope distance, horizontal distance and inclination data) and then automatically request and communicate the angle to the device 100 to capture the horizontal angle. The device 100 can then automatically downloads the value to the app to create a complete HV serial string. The smartphone app can provide for a “remote” Fire capability for both the laser and the device 100.

A Fire laser rangefinder send command can serve to capture the measurements and automatically request/communicate the angle to the device 100 to capture the horizontal angle. The device 100 may automatically downloads the value to the app to create a complete HV serial string. A request current angle command can send a command to the device 100 to capture the current horizontal angle measurement and downloads the value to the app.

With respect to the battery charge status indicator 120, from a power off state, only the on/off button 114 may be active. A short press of the button 114 can light up the indicator 120 and show the battery status for a determined period of time (e.g., a programmable 3 seconds) and then power off again. Upon powering up of the device 100, the indicator 120 can turn on and display the current battery life for 3 seconds and then go out. This time period may also be programmable.

When the device 100 is powered on, a short press of the on/off button 114 can illuminate the battery charge status indicator 120 and indicates the current battery life for a determined period and then it goes off. When the battery voltage changes levels, the indicator 120 can automatically display the current status of the battery charge level for a programmable time period (e.g., 3 seconds) and then turn off.

In a representative embodiment of the device 100, the battery charge status indicator 120 can display 3 segments at a full charge of 3.2 volts, then 2 segments, and finally 1 segment at lower determined voltage levels. When a low battery voltage is sensed, the single segment may begin flashing indicating that the battery either needs to be charged or replaced.

With reference specifically to the level aid LEDs 119, twelve such indicators can be shown to effectively serve as a “bubble level” to assist a user of leveling the device 100. It should be noted that any number of such LEDs 119 might be utilized in any configuration and the following description is merely exemplary of what might be utilized in a representative embodiment of the present technology. The level aid LEDs 119 can operate in conjunction with the device 100 processor and an associated set of accelerometers as will be more fully disclosed and described hereinafter.

The level aid LEDs 119 can assist a user of the device 100 to obtain the highest degree of positional accuracy for horizontal angle measurement by indication when the device 100 is tilted from plumb or otherwise out of tolerance. The LEDs 119 can serve to alert a user when the device 100 is outside of a user-defined limit. If the device 100 is out of level defined settings, no horizontal angle measurement can then be taken or downloaded to an associated laser rangefinder. In an alternative embodiment of the present technology, data taken even when the device is out of level may provisionally be stored along with any accurate level data and any “bad” data can be subsequently qualified by correction to a known GPS fix.

As illustrated, the LEDs 119 may be arranged in 4 quadrants and may, in a particular embodiment comprise red LEDs. The LEDs 119 can be configured to mimic a “bubble” level in the manner in which they are illuminated and to indicate the direction in which the device 100 must be repositioned in order to re-level it.

As an example, if the device 100 is off-level, a larger number of the LEDs 119 (e.g., 7 when 12 are utilized) may not illuminate and indicate an extreme off-level condition. This represents the device 100 needs to be tilted in the direction of the 5 illuminated LEDs 119 to begin leveling the device 100. As the device 100 is then brought toward level the number of LEDs 119 illuminated can decrease until only one remains illuminated.

Once fully level, all LEDs may then be illuminated indicating for a brief moment indicating that the device 100 is fully level and then 4 LEDs 119 at the 3, 6, 9 and 12 o'clock portions can be illuminated to indicate that the device 100 is now level. Should the device 100 then be moved out of level, from 1 to 7 of the LEDs 119 can reverse the procedure indicated previously. If the can 100 is rotated while in use, the level aid LEDs will continue simulating a “bubble” level. In a particular implementation of the present technology, haptics may also be employed to indicate to a user that the device 100 has been moved in or out of a level condition.

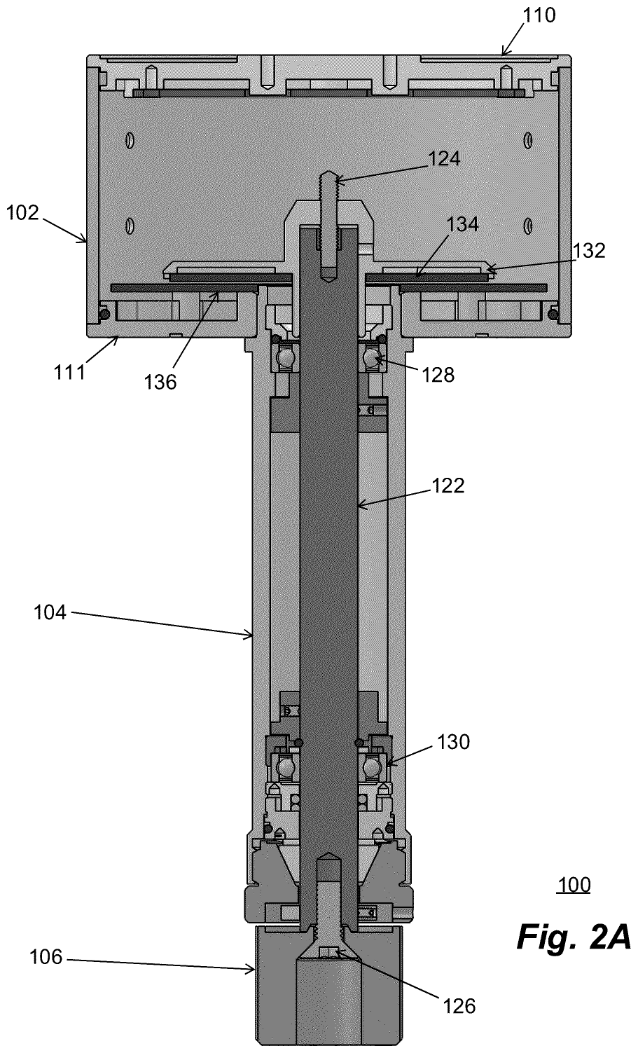

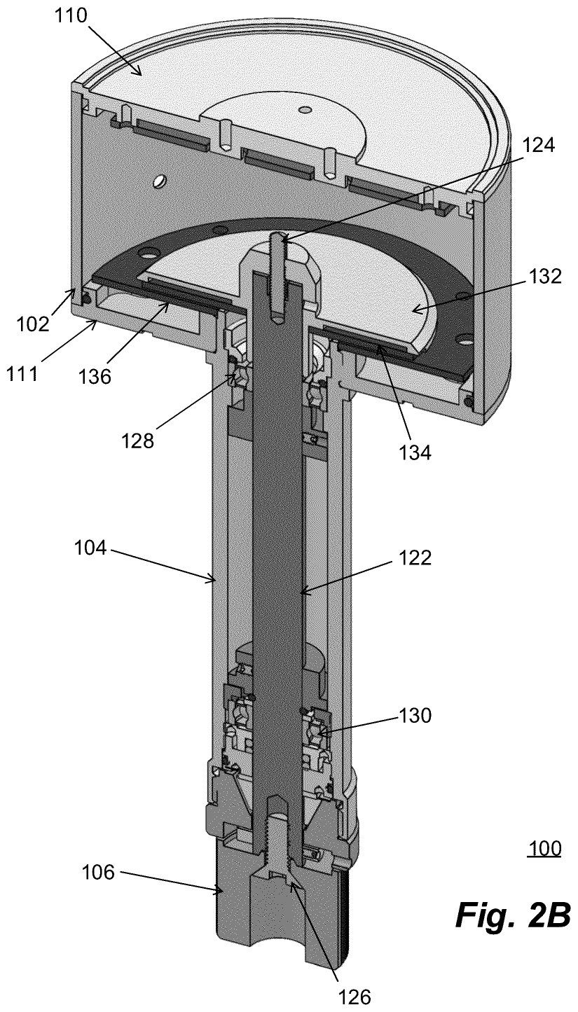

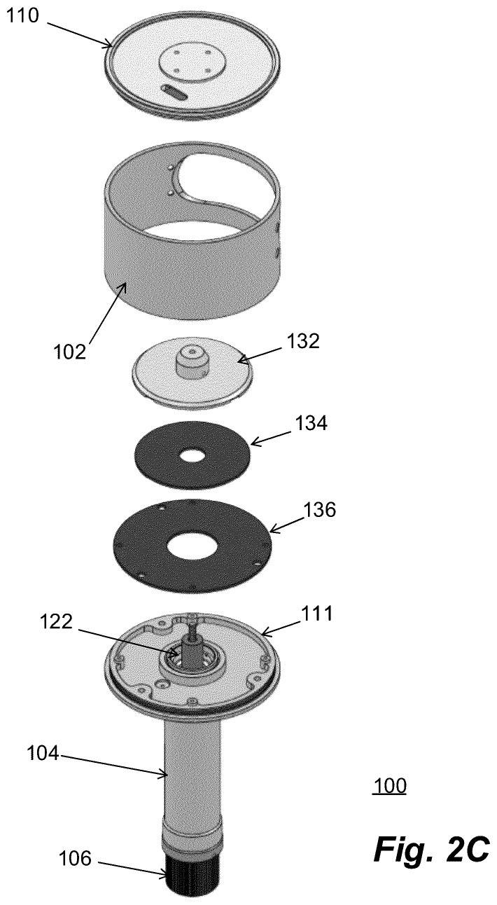

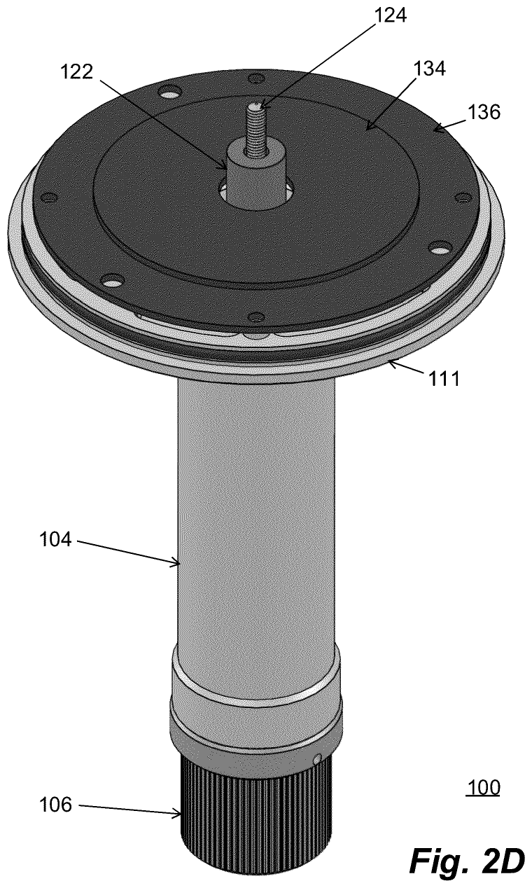

With reference additionally now to FIG. 2A, a cut-away side elevational view of the representative device 100 of the preceding figures is shown illustrating additional internal structure thereof. In pertinent part the device 100 comprises a housing 102, an outer cylinder 104 extending towards a pole, staff or tripod mount 106. The housing 102 can be defined by a top plate 100 and an oppositely disposed bottom plate 111.

A shaft 122 can be disposed within the outer cylinder 104 around which the housing 102 and outer cylinder 104 may be rotated as the shaft 122 is allowed to rotate between bearings 128 and 130. A screw 124 can secure a rotor board mount 132 with rotor (or rotor board) 134 to the shaft 122 which, in turn can be coupled to the pole/staff/tripod mount 106 by means of another screw 126 at an opposite end thereof. A resolver (or resolver board) 136 can be secured to the bottom plate 111 of the housing 102 and can then be rotatable with the housing 102 and outer cylinder 104 with respect to the rotor board 134.

Stated another way, the shaft 122 can be fixed to a pole/staff/monopod/tripod at the mount 106. The rotor board 134 can be fixed to the shaft 122 and does not itself rotate. The entire device 100 may then rotate around these fixed components. The resolver board 136 can be affixed to the bottom plate 111 of the housing 102 and rotates with it with respect to the rotor board 134. In alternative embodiments of the present technology the rotor board 134 may be configured to be rotatable with respect to a relatively fixed position resolver board 136 unlike the representative embodiment of the present technology illustrated and disclosed.

With reference additionally now to FIG. 2B, a cut-away, isometric view of the device 100 of the preceding figure is shown illustrating another view of the internal structure thereof.

With reference additionally now to FIG. 2C, an exploded isometric view of the device 100 of the preceding figure is shown illustrating in greater detail the rotor and resolver boards.

With reference additionally now to FIG. 2D, an enlarged isometric view of a portion of the device 100 of FIGS. 2A-2C is further shown illustrating the relationship between the rotor 134 and resolver boards 136.

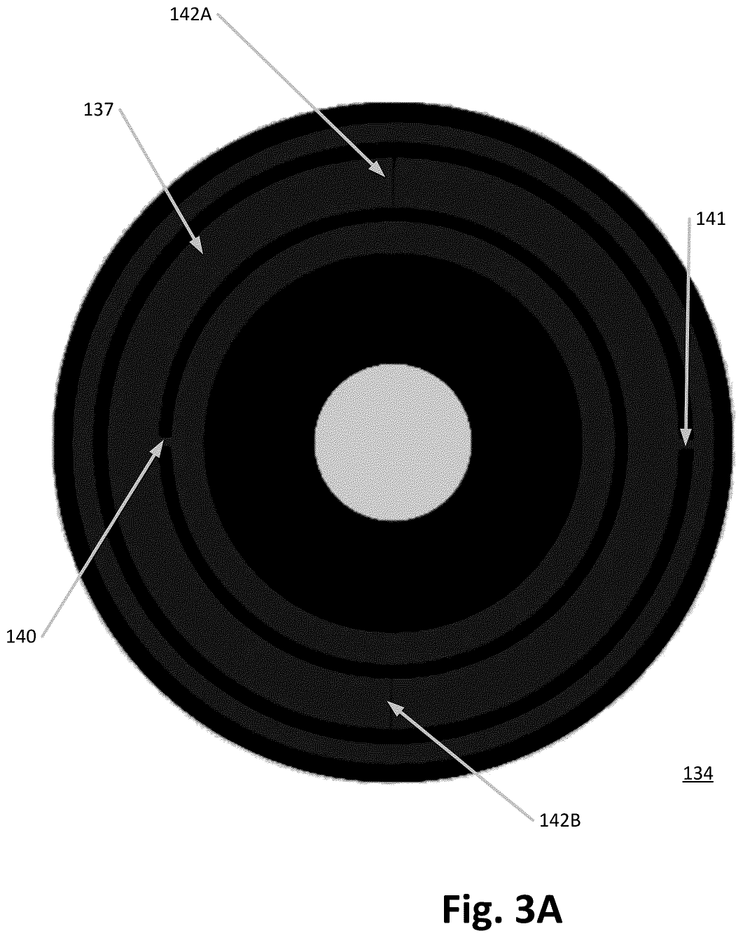

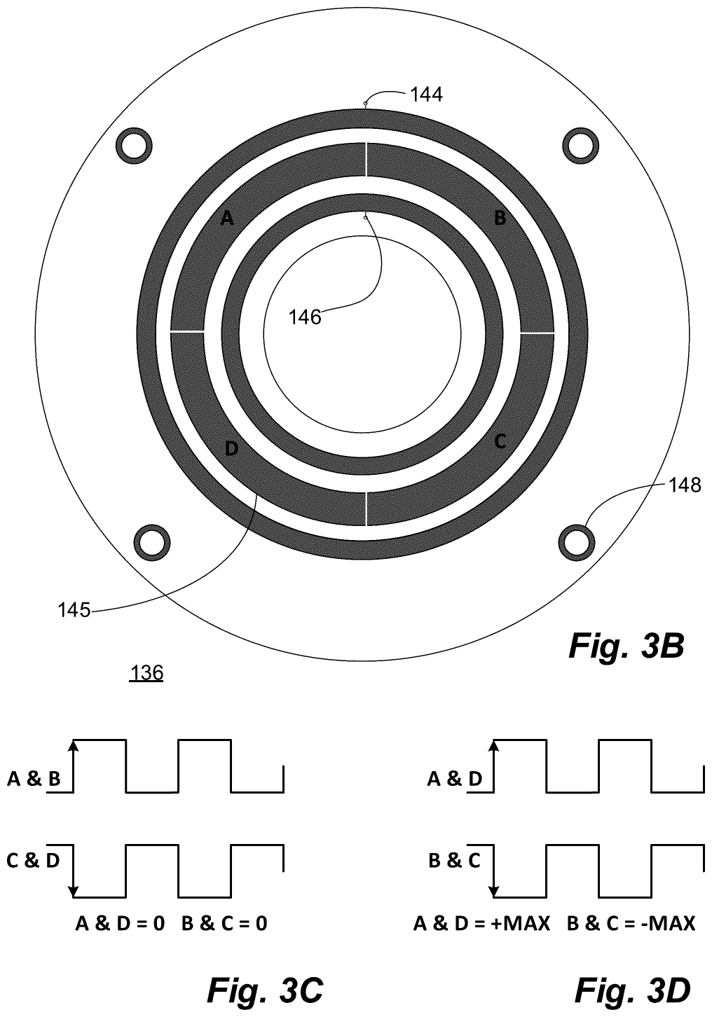

With reference additionally now to FIG. 3A, a bottom plan view of a possible rotor board 134 configuration in accordance with a representative embodiment of the device 100 is shown as illustrated in the preceding figures. In a representative embodiment of the rotor board 134 it may be conveniently provided comprising an FR-4 circuit board substrate upon which a number of annular copper rings have been formed.

As illustrated, the rotor board 134 may incorporate a pickup ring 137 which can be divided into two halves by oppositely disposed gaps 142A and 142B. An outer ring of the rotor board 134 can be connected through gap 141 to the right half of the pickup ring 137 while an inner ring of the rotor board 134 can be coupled to the left half of the pickup ring 137 by gap 140.

With reference additionally now to FIG. 3B, a top plan view of a possible resolver board 136 configuration in accordance with the representative embodiment of the device 100 is shown as illustrated in the preceding figures for use in conjunction with the rotor board 134 of FIG. 3A. As with the rotor board 134, the resolver board 136 may be conveniently constructed from an FR-4 circuit board substrate having a number of copper annular rings formed thereon. It should be noted that in the representative embodiment of the present technology, the resolver board 136 can be comprised of more than one associated circuit boards (not shown) containing interconnected electrical and electronic components of the device 100 and coupling signals to certain segments of the resolver board. Functionally, the resolver board 136 can be capacitively coupled to the rotor board 134 providing a value dependent upon the two boards 134, 136 relative position.

As shown, the resolver board 136 may incorporate a number of mounting holes 148 for securing it to the bottom plate 111 along with the associated other circuit boards. The resolver board 136 may comprise an outer ring having a connecting point 144 (OUTER) disposed radially outward therefrom. In like manner, the resolver board 136 may further comprise an inner ring having an inwardly disposed connecting point 146 (INNER). A medially disposed middle ring 145 between the inner and outer rings can comprise four separate 90° segments individually denominated as A, B, C and D.

With reference additionally now to FIGS. 3C and 3D, respectively illustrated are the resultant demodulated states of segments A&D and B&C as differential square wave signals of quadrants A&B with C&D as well as quadrants A&D with B&C. In the former instance, (FIG. 3C) A&D=0 and B&C=0 while in the latter instance, (FIG. 3D) A&D=+Max while B&C=−Max.

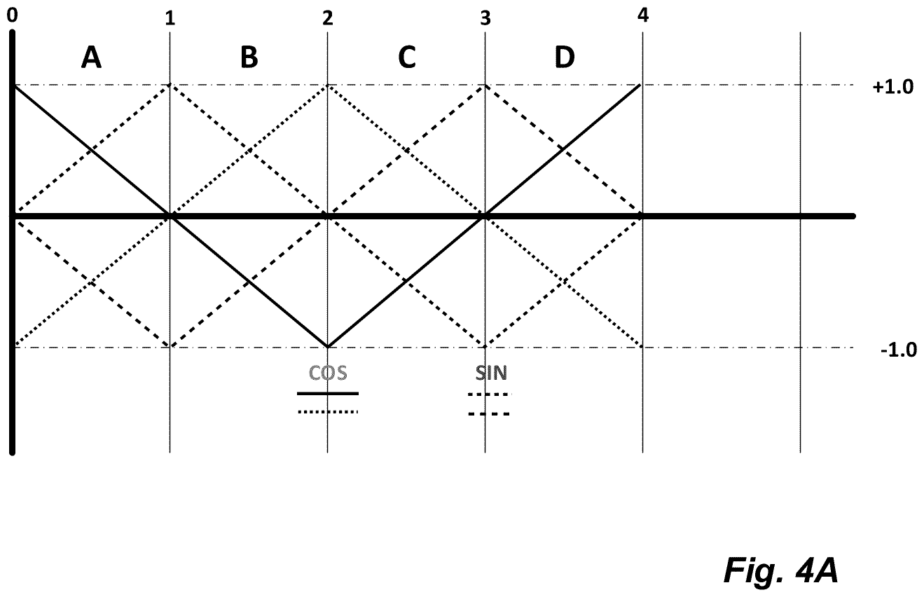

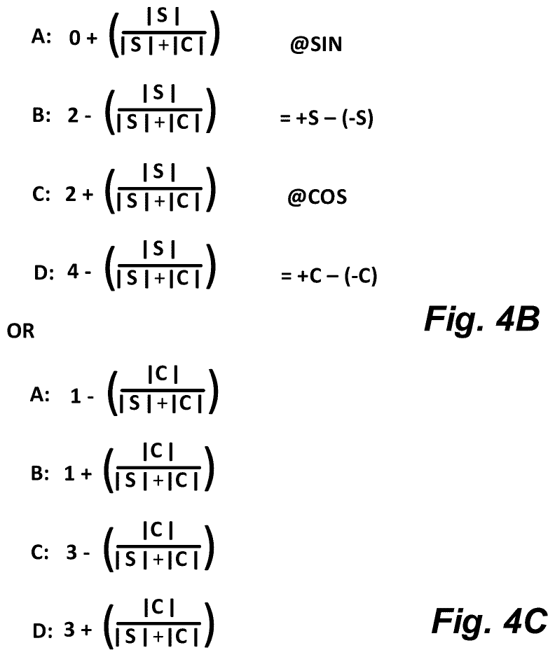

With reference additionally now to FIG. 4A, illustrated are the cosine (COS) and sine (SIN) states of each of segments A, B, C, D as differential triangular wave signals which are the result of the demodulation of square wave signals at these segments at positions 0 through 4 and the resultant outputs varying between +1.0 and −1.0.

With reference additionally now to FIGS. 4B and 4C, illustrated are the calculations for the values of segments A, B, C, D of the preceding figures with respect to the absolute value of the sine and cosine for each of these segments.

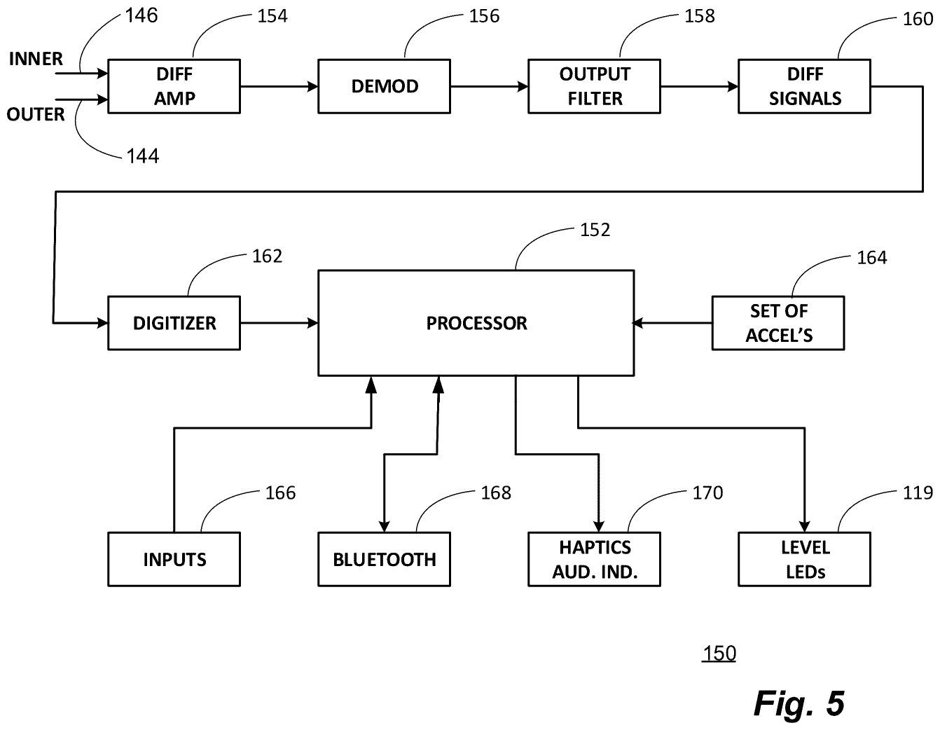

With reference additionally now to FIG. 5, a high-level functional block diagram 150 illustrative of possible circuitry for implementing the functional and operational characteristics of the representative device 100 of the preceding figures is shown. A processor 152, which in a representative embodiment may be provided as a STMicroelectronics STM32G071RBT6 ARM Cortex microcontroller, receives a number of inputs and provides responsive output signals in the functionality of the representative device 100 of the present technology.

As illustrated, the INNER 146 and OUTER 144 connection points of the resolver board 136 can be coupled to a differential amplifier 154, the output of which can be provided to a demodulator 156. The output of the demodulator 156 can then be passed through an output filter 158 to provide differential signals 160 to a digitizer 162 for input to the processor 152. A set of accelerometers 164 may also provide inputs to the processor 152 with regard to the position of the device 100 with respect to its level, or off from level, when in operation.

Manual inputs 166 to the device 100 can be passed to the processor 152 by, for example, the power on/off button 114, the Bluetooth pairing button 116, and the Fire/zero button 118. Bluetooth communication with an associated laser rangefinder or smart device can be communicated with the processor 152 by means of Bluetooth block 168. The processor 152 may also control indications to a user of the device 100 through haptics and/or audible sounds through block 170 while the level aid LEDs 119 provide an indication of the level of the device 100 to a user in a visual format through block 172.

While there have been described above the principles of the present technology in conjunction with a representative apparatus, it is to be clearly understood that the foregoing description is made only by way of example and not as a limitation to the scope of the technology. Particularly, it is recognized that the teachings of the foregoing disclosure will suggest other modifications to those persons skilled in the relevant art. Such modifications may involve other features which are already known, per se, and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same technology as presently claimed in any claim and whether or not it mitigates any or all of the same technical problems as confronted by the present technology. The applicants hereby reserve the right to formulate new claims to such features and/or combinations of such features during the prosecution of the present application or of any further application derived therefrom.

As used herein, the terms “comprises”, “comprising”, or any other variation thereof, are intended to cover a non-exclusive inclusion, such that a process, method, article, or apparatus that comprises a recitation of certain elements does not necessarily include only those elements but may include other elements not expressly recited or inherent to such process, method, article or apparatus. None of the description in the present application should be read as implying that any particular element, step, or function is an essential element which must be included in the claim scope and THE SCOPE OF THE PATENTED SUBJECT MATTER IS DEFINED ONLY BY THE CLAIMS AS ALLOWED. Moreover, none of the appended claims are intended to invoke paragraph six of 35 U.S.C. Sect. 112 unless the exact phrase “means for” is employed and is followed by a participle.

What is claimed is:

1. A precise bearing measurement device comprising:
a housing rotatably supported about a shaft couplable to a support, the housing being couplable to a rangefinder,
a rotator board within the housing coupled to the shaft and a parallel and spaced apart resolver board capacitively coupled therewith, the housing being affixed to the resolver board;
a processor coupled to receive a signal indicative of a relative position of the rotator and resolver boards indicative of a horizontal bearing of the resolver board and the housing; and
a wireless communication medium for communicating the horizontal bearing to the rangefinder.

2. The device of claim 1 wherein the resolver board is rotatable with the housing with respect to the rotator board.

3. The device of claim 1 wherein the rotator and resolver boards each comprise a substrate having annular conductive rings formed thereon.

4. The device of claim 1 wherein the support comprises one of a GPS pole, a monopole, or a tripod.

5. The device of claim 1 wherein the wireless communication medium comprises one of Bluetooth Classic or Bluetooth Low Energy.

6. The device of claim 1 wherein the rangefinder is coupled to the housing by means of a hinge allowing vertical translational movement of the rangefinder while remaining aligned with the horizontal bearing of the resolver board.

7. The device of claim 1 further comprising:
a set of accelerometers coupled to the processor for indicating a level horizontal position of the device in operation.

8. The device of claim 7 wherein the processor and the accelerometers are operative to preclude communicating the horizontal bearing to the rangefinder when the device is outside of the level horizontal position.

9. The device of claim 8 wherein the processor and the accelerometers are operative to indicate an unlevel horizontal position of the device.

10. The device of claim 9 wherein the processor and the accelerometers are operative to indicate a direction to orient the device to achieve the level horizontal position of the device.

11. A precise bearing measurement device comprising:
a rotor comprising a plurality of concentric annular conductive rings formed on a lower planar surface thereof:
a resolver comprising a number of concentric annular conductive rings formed on an upper surface thereof spaced apart from and opposing the rotor lower planar surface, the conductive rings of the rotor and the resolver being capacitively coupled and relatively rotatable with respect to one another; and
a processor coupled to selected segments of at least one of the number of resolver conductive rings for providing an indication of a respective position of the rotor and resolver with respect to one another establishing a horizontal bearing of the device.

12. The device of claim 11 further comprising:
a wireless communication medium for communicating the horizontal bearing to a rangefinder.

13. The device of claim 12 further comprising:
a housing rotatably supported about a shaft couplable to a support, the housing being couplable to the rangefinder.

14. The device of claim 13 wherein the rotator is coupled to the shaft and the housing is affixed to the resolver.

15. The device of claim 13 wherein the support comprises one of a GPS pole, a monopole, or a tripod.

16. The device of claim 11 further comprising:
a wireless communication medium coupled to the processor comprising one of Bluetooth Classic or Bluetooth Low Energy.

17. The device of claim 12 wherein the rangefinder is coupled to the housing by means of a hinge allowing vertical translational movement of the rangefinder while remaining aligned with the horizontal bearing of the resolver.

18. The device of claim 11 further comprising:
a set of accelerometers coupled to the processor for indicating a level horizontal position of the device in operation.

19. The device of claim 12 wherein the processor and the accelerometers are operative to preclude communication of the horizontal bearing to the rangefinder when the device is not in the level horizontal position or alternatively storing off-level bearing data for subsequent qualification by correction to a known GPS fix.

20. The device of claim 18 wherein the processor and the accelerometers are operative to indicate an unlevel horizontal position of the device.

21. The device of claim 18 wherein the processor and the accelerometers are operative to indicate a direction to orient the device to achieve the level horizontal position of the device.

22. A range pole leveling device comprising:
a processor;
a set of accelerometers coupled to the processor for sensing a level or off-level position of the device;
a plurality of level indicating LEDs coupled to the processor and peripherally disposed about the pole wherein one or more of the LEDs are operative to illuminate when the device is at the level position or the off-level position.

23. The device of claim 22 wherein certain of the LEDs are operative to indicate a direction to orient the device to achieve the level position of the device from the off-level position.

24. The device of claim 22 wherein the processor and the accelerometers are operative to preclude communicating a bearing to an associated rangefinder when the device is in the off-level position or alternatively storing bearing data from the off-level position for subsequent qualification by correction to a known GPS fix.
